(19) United States
(12) Patent Application Publication
(10) Pub. No.: US 2017/0063495 A1
(43) Pub. Date: Mar. 2, 2017

(54) AUDIO SIGNAL TRANSMISSION SYSTEM AND DATA PROCESSING METHOD FOR ENHANCING DATA ACCURACY OF THE SAME

(71) Applicant: RED SUNRISE CO., LTD., Taipei City (TW)

(72) Inventor: Yu-Hung CHEN, Taipei City (TW)

(21) Appl. No.: 14/839,566

(22) Filed: Aug. 28, 2015

(51) Int. Cl. H04L 1/00; H04L 27/22; H04L 1/20; H04L 27/20; H04B 11/00; G08C 23/02

(52) U.S. Cl. CPC H04L 1/0083; H04B 11/00; H04L 1/0041; H04L 1/0054; G08C 23/02; H04L 1/206; H04L 1/0061; H04L 1/0057; H04L 1/006; H04L 27/20; H04L 27/22; H04L 2001/0093

(57) ABSTRACT

An audio signal transmission system includes a first device and a second device. The first device transmits audio signals to the second device for the second device to receive and process. After converting a piece of information read by the first device into digital data, the first device arranges the digital data to acquire a matrix, performs error control coding algorithm to rearrange and code continuous data in the matrix to generate a byte sequence, and modulates the byte sequence to generate a set of audio signals for transmission. The second device receives and modulates the set of audio signals to acquire the byte sequence, and performs an error control decoding algorithm to correctly acquire the piece of information. Accordingly, data accuracy through the audio signal transmission can be ensured, and the issue of massive uncorrectable continuous data upon audio signal transmission over the air can be tackled.

### BACKGROUND OF THE INVENTION

1. Field of the Invention

The present invention relates to an audio signal transmission system and, more particularly, to an audio signal transmission system and a data processing method for enhancing data accuracy of the audio signal transmission system.

2. Description of the Related Art

Owing to the progress of science and technology, using mobile device to transmit and receive information through mobile communication or wireless communication has become a rather commonplace technique. Recently, the technique of transmitting data over sound wave, such as data over sonic wave (DSW), is also available. Also given transmission of URL (Uniform Resource Locator) information as an example, mobile phones can be taken by users to approach televisions so as to receive a wide variety of information associated with the content playing on the televisions, including introduction of a concert, purchase information, electronic coupons offered by some retailing stores and the like. Speaking of the DSW technique, frequency modulation is usually adopted with high and low frequencies representing the binary bit values 0 and 1. However, frequency modulation for such transmission generally has the shortcoming of slow transmission speed. In other words, when frequency varies too fast in a short period of time, transmission of audio waves over air is prone to non-uniform transmission speed, which causes failure of correctly recognizing frequency variations of audio waves because of simultaneous arrivals of the audio waves with different frequencies at a receiving device. Therefore, frequency has to be changed in an inefficient manner from time to time.

With reference to FIG. 8, a conventional system for transmitting data and control commands over audio wave includes an audio broadcasting device 91 and an audio receiving device 92. Users can operate the audio broadcasting device 91 to input character strings or commands and convert the character strings or commands into an audio file to be broadcasted. The broadcasted audio waves are transmitted over the air to the audio receiving device 92 and are processed by the audio receiving device 92 to acquire the character strings or control commands in the audio waves after the audio waves are received, such that a corresponding action is automatically performed according to the acquired character strings or control commands. Thus, users can control the audio receiving device 92 to perform a requested service by using the audio broadcasting device 92 for audio broadcasting. As to how to use the audio broadcasting device 91 to transmit the character strings or control commands in the form of audio waves and how to use the audio receiving device 92 to receive the audio waves, with reference to FIGS. 9 and 10, the audio broadcasting device 91 and the audio receiving device 92 are used to perform the following steps. The audio broadcasting device 91 receives a user-inputted character string, converts the character string into binary data, modulates the binary data to an audio file through phase shift keying (PSK) modulation, determines if the audio file is compressed according to a default mode, performs lossy/lossless compression and broadcasts the compressed audio file if positive, and directly broadcasts the audio file if negative. When receiving a set of audio signals, the audio receiving device 92 demodulates the set of audio signals, converts the demodulated set of audio signals into a character string, and determines a following action to be taken according to the character string.

Basically, PSK modulation involves the use of phase variations of audio waves indicative of binary bit values “0” and “1”, and requires no frequency change upon transmission of audio waves, which significantly reduces the time interval required to transmit different bits and improves the issue in the conventional technique that inefficiently alters frequency occasionally. As PSK modulation technique originally focuses on transmission of electromagnetic waves and the transmission speed of electromagnetic wave is the speed of light, the phase shift of electromagnetic waves generated after the electromagnetic waves travel a distance in air is extremely small. Since audio waves travel through the air at the speed of sound, which is 880 thousand times slower than the speed of light and the transmission speed of audio waves varies with density differences in a medium when audio waves travel through the medium, the phase shift of audio waves is augmented after travelling a distance through the air. If the audio receiving device 92 directly decrypts the audio waves, massive continuous error bits will be read. Despite no change of frequency, PSK modulation has a lower accuracy of data.

From the foregoing description, regular transmission system normally enhances communication quality of data transmission channel and lowers the error rate of data in transmission to ensure higher accuracy in data transmission. However, air is an unstable communication channel that causes a low signal to noise ratio (SNR) of audio waves transmitted therein. As far as the conventional technique of audio wave transmission is concerned, the audio broadcasting device 91 first performs PSK modulation on audio waves before transmitting the audio waves, the transmitted audio waves are subject to irregular phase variations due to the medium or distance involved in transmission of the audio waves, large quantity of successive erroneous bits that are received by the audio receiving device 92 fail to be corrected such that information contained in the audio waves should be discarded instead of being correctly read out, and retransmission should continue.

### SUMMARY OF THE INVENTION

An objective of the present invention is to provide a data processing method for enhancing data accuracy of an audio signal transmission system and an audio signal transmission system that prevent massive successive erroneous bits received from being over-concentrated and uncorrectable and enhances accuracy of data contained in audio signals upon transmission of audio signals.

To achieve the foregoing objective, the data processing method for enhancing data accuracy of an audio signal transmission system, in which the audio signal transmission system has a first device and a second device and the first device transmits audio waves to the second device for the second device to receive, is performed by the first device and includes steps of:
receiving a piece of information and converting the piece of information into digital data;
rearranging the digital data to generate a matrix;
performing an error control coding algorithm to code and sequentially rearranging data in the matrix in generation of a byte sequence;
adding a header to the byte sequence to create a bit sequence and then modulating the bit sequence to generate a set of audio signals; and
transmitting the set of audio signals to the second device for the second device to receive.

Preferably, the data processing method is performed by the second device and includes steps of:

receiving the set of audio signals;

converting the set of audio signals;

demodulating the converted set of audio signals to acquire the bit sequence; and

reading the byte sequence according to the header contained in the bit sequence and performing the error control decoding algorithm on the byte sequence to acquire a piece of information.

To achieve the foregoing objective, the audio signal transmission system includes a first device and a second device.

The first device has an audio transmitting unit, a coder and a first processor.

The first processor is connected to the audio transmitting unit and the coder and transmits audio signals through the audio transmitting unit.

The second device pairs with the first device and has an audio receiving unit, a decoder and a second processor.

The audio receiving unit receives the audio signals.

The second processor is connected to the audio receiving unit and the decoder, receives the audio signal sent from the audio receiving unit, and processes and demodulates the audio signals.

The first device and the second device perform the foregoing data processing method.

According to the forgoing description, the way of converting the piece of information into the digital data, rearranging the digital data to generate the matrix, and performing the error control coding algorithm at the side of the first device targets at data separation for avoidance of uncorrectable data because of over-concentrated erroneous data in transmission. On the other hand, according to the foregoing steps associated with the second device, the way of reading the byte sequence and performing the error control decoding algorithm on the byte sequence at the side of the second device targets at correctly retrieving the piece of information contained in the audio signals transmitted by the first device. Accordingly, the issue of massive successive and over-concentrated erroneous bits that are uncorrectable can be resolved.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of an audio signal transmission system in accordance with the present invention;

FIG. 2 a schematic diagram of data structures of information coded by a first device of the audio signal transmission system in FIG. 1 in a coding sequence;

FIG. 3 is a flow diagram of a data processing method of the first device of the audio signal transmission system in FIG. 1;

FIG. 4 is a flow diagram of error control coding algorithm performed by the first device of the audio signal transmission system in FIG. 1;

FIG. 5 is a flow diagram of a data processing method of a second device of the audio signal transmission system in FIG. 1;

FIG. 6 is a flow diagram of data modulation and conversion algorithm of the second device of the audio signal transmission system in FIG. 1;

FIG. 7 is a flow diagram of error control decoding algorithm performed by the second device of the audio signal transmission system in FIG. 1;

FIG. 8 is a functional block diagram of a conventional system for transmitting data and control commands over audio waves;

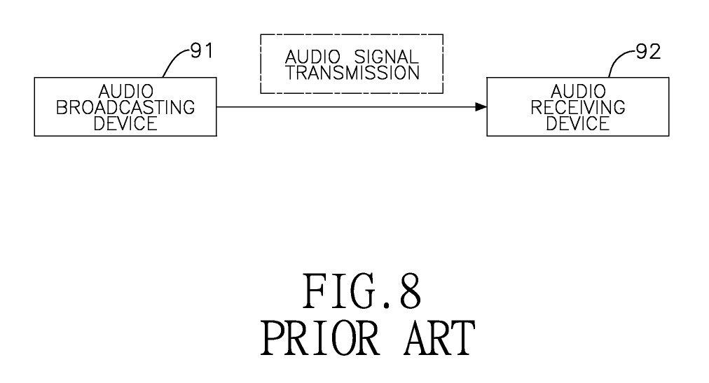

FIG. 9 is a flow diagram of a process of broadcasting audio waves by an audio broadcasting device of the conventional system in FIG. 8; and

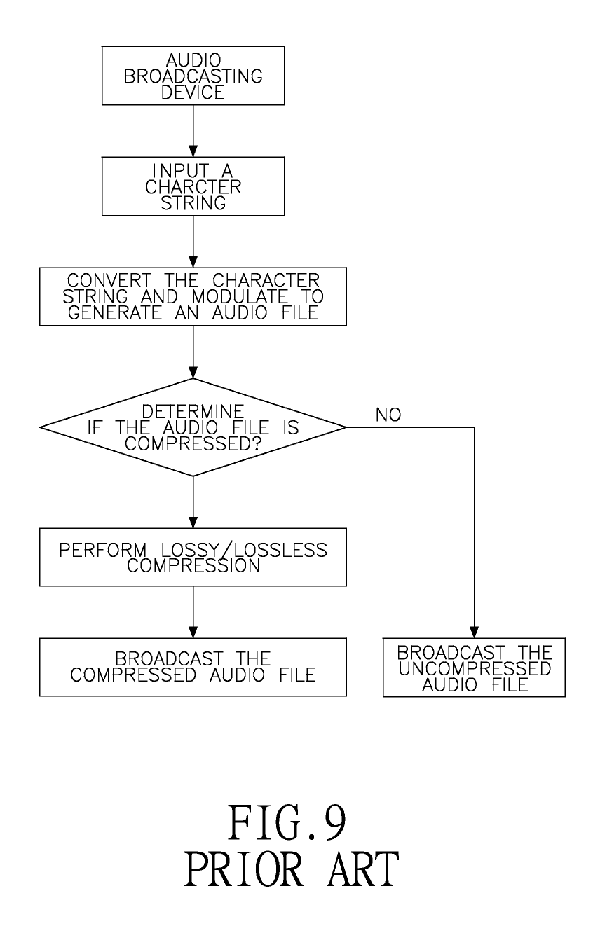

FIG. 10 is a flow diagram of a process of receiving audio waves by an audio receiving device of the conventional system in FIG. 8

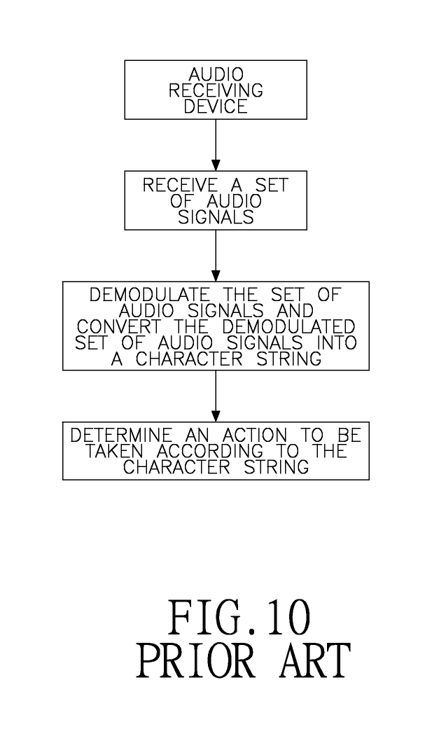

### DETAILED DESCRIPTION OF THE INVENTION

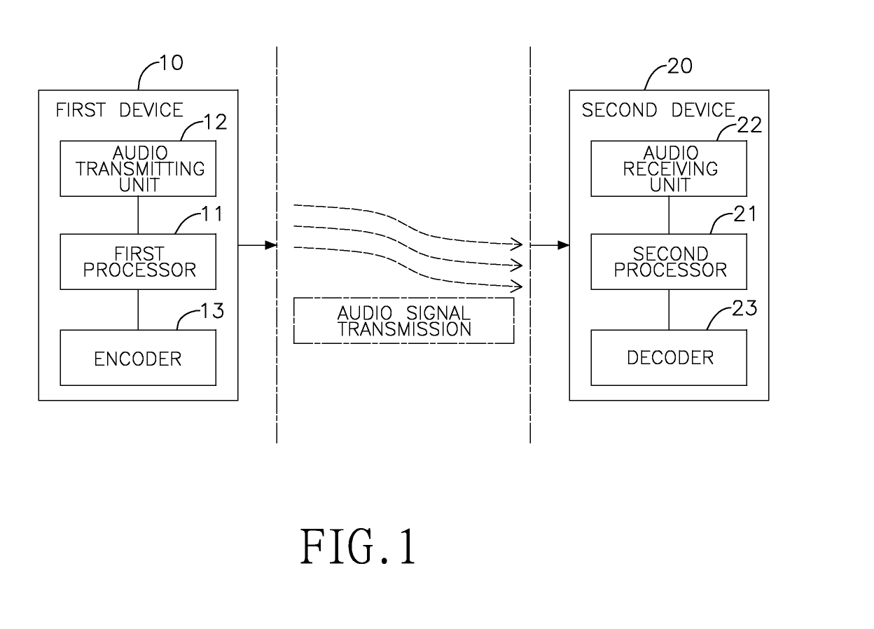

With reference to FIG. 1, an audio signal transmission system in accordance with the present invention has a first device 10 and a second device 20.

The first device 10 transmits a set of audio waves through a medium, such as air, to the second device 20. The set of audio waves indicates a set of continuous audio signals transmitted through the air, and can be generally referred to all kinds of sounds heard by human ears. In the present embodiment, each of the first device 10 and the second device 20 is an electronic device, such as a mobile device, a smart device, a computer or the like.

The first device 10 includes a first processor 11, an audio transmitting unit 12, an encoder 13 and an input unit. The first processor 11 is connected to the audio transmitting unit 12, the encoder 13 and the input unit, and stores information built in or pre-stored in the first processor 11 or inputted through the input unit. The first processor 11 reads a piece of information, converts the piece of information into digital data, adds a check code to the digital data, and rearranges the digital data in the form of a matrix. The encoder 13 performs an error control coding algorithm to code and sequentially rearrange data in the matrix in generation of a byte sequence, and further adds a header to the byte sequence to create a bit sequence. After reading the bit sequence, the first processor 11 modulates the bit sequence to a set of audio signals and the audio transmitting unit 12 transmits the set of audio signals through the air for the second device 20 to receive.

The second device 20 includes a second processor 21, an audio receiving unit 22 and a decoder 23. The second processor 21 is connected to the audio receiving unit 22 and the decoder 23. The audio receiving unit 22 serves to receive the set of audio signals transmitted from the first device 10 and sends the set of audio signals to the second processor 21 for the second processor 21 to process and demodulate the set of audio signals. After the second device 20 receives the set of audio signals containing the piece of information, the second processor 21 processes the set of audio signals with filtering and demodulation to acquire the bit sequence with the header, and identifies the bit sequence according to the header. The decoder 23 performs an error control decoding algorithm that pairs with the error control coding algorithm and serves to accurately and correctly acquire the piece of information contained in the set of audio signals. As audio waves transmitted through the air are susceptible to a variety of environmental variables, massive continuous error-prone data that fail to be corrected are likely to happen. Therefore, the encoder 13 of the first device 10 performs the error control coding algorithm to divide the set of continuous audio signals and code and sequentially rearrange the digital data converted from the set of audio signals with a mathematical approach, so as to prevent received erroneous bits arising from burst errors in the course of transmission from being over-concentrated and uncorrectable. The decoder 23 of the second device 20 performs the pairing error control decoding algorithm to not only correctly acquire the piece of information but also increase accuracy and enhance performance of the system.

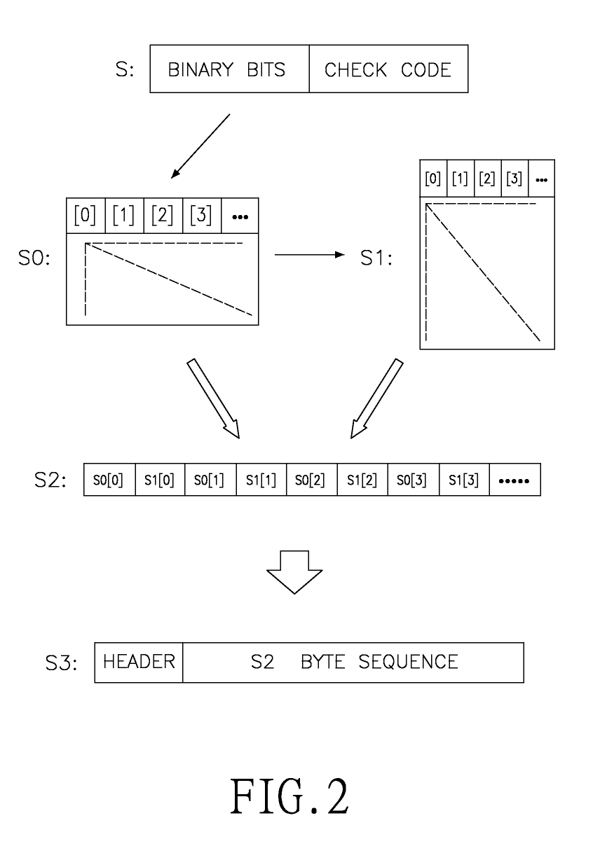

With reference to FIG. 2, data structures of information coded by the first device in a coding sequence are shown. The first processor 11 of the first device 10 reads the piece of information. The piece of information may be a character string. When the piece of information is converted, the piece of information is converted into the digital data S that are ASCII (American Standard Code for Information Interchange) codes corresponding to the character string. The digital data S include a set of binary bit values. The check code is added to the digital data S and a bitwise rotation is applied to the digital data S with bits of the digital data S sequentially allocated to elements of a matrix S0 (“S0:[0][1][2][3] . . . ”). The encoder 13 further performs the error control coding algorithm on the matrix S0 to generate a transpose matrix S1 (“S1:[0][1][2][3] . . . ”) from the matrix S0, alternately and sequentially assign values of the elements in the matrix S0 and the transpose matrix S1 to corresponding bits of a byte sequence S2 (“S0[0], S1[0], S0[1], S1[1], S0[2], S1[2], . . . ), and adds a header to the byte sequence S2 to generate a bit sequence S3. The bit sequence is modulated to generate a set of audio signals that is transmitted to the second device 20.

When the second processor 21 of the second device 20 receives the set of audio signals, the set of audio signals is filtered and demodulated to acquire the bit sequence S3 with the header. The content of the byte sequence S2 is read according to the header in the bit sequence S3. The decoder 23 performs the pairing error control decoding algorithm to restore the matrix S0 and the transpose matrix S1 from the content of the byte sequence S3 to acquire erroneous bit values, and to identify all possible paths using the Trellis diagram and the path with a minimum Hamming distance to acquire correct piece of information with the highest possibility. In the present embodiment, the second processor 21 filters and demodulates the set of audio signals to acquire the time-based bit sequence. The second processor 21 has a band pass filter and a Fast Fourier Transform (FFT) filter for filtering and demodulating the set of audio signals.

An application of the present invention is described as follows. The first device 10 converts a character string into binary bit values, codes the binary bit values based on forward error correction (FEC) codes, modulates the coded bits to generate a set of audio signals, and transmits the set of audio signals to the second device 20. When receiving the set of audio signals, the second device 20 demodulates the set of audio signals to acquire the bit sequence and decodes the bit sequence to generate a character string. Upon using the FEC codes in transmission of audio signals, massive erroneous bits can be corrected. What worth mentioning is that the FEC codes are featured by redundant bits added to the transmitted information in a specific manner and allow erroneous data in the course of transmission to be correctable. The common types of FEC codes include Reed Solomon codes, convolutional codes, Turbo codes and the like.

To enhance accuracy of data in data transmission, regular communication systems are designed to ensure higher communication quality through data transmission channels and reduce the possibility of erroneous data in transmission. However, when audio waves are transmitted through the air, the air in nature pertains to an unstable transmission channel with low SNR to audio waves. Therefore, a coding technique with error correction is applied to correct erroneous bits caused in transmission. Preferably, the pairing error control coding algorithm and the error control decoding algorithm may be combinations of convolutional coding and Viterbi decoding, Trellis coded modulation (TCM) coding and Viterbi decoding, a Turbo coding and Viterbi decoding, and linear block coding and Viterbi decoding.

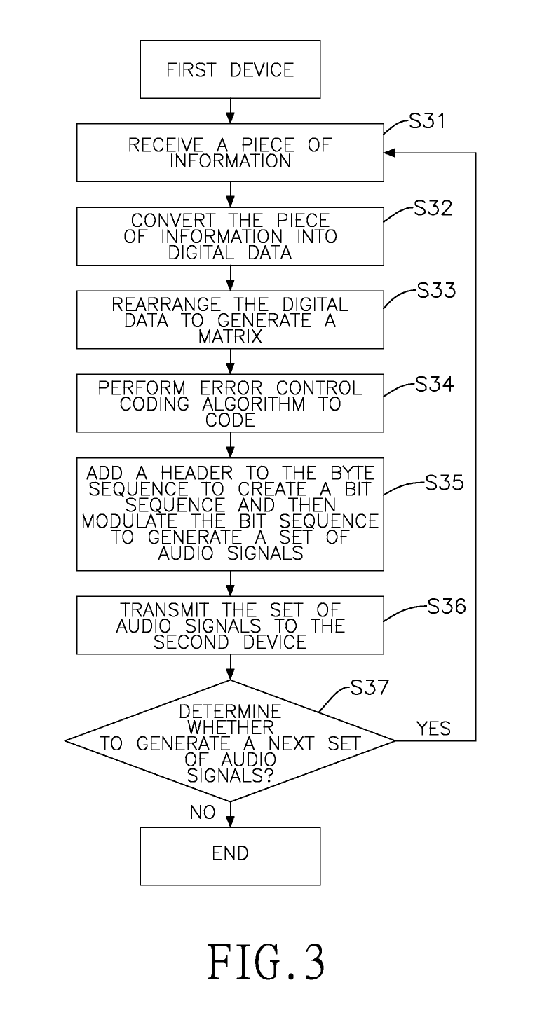

A data processing method for enhancing data accuracy of the audio signal transmission system can be deduced from the description of the foregoing embodiment. The data processing method is performed by the audio signal transmission system. With reference to FIGS. 2 and 3, the first device 10 transmits audio signals to the pairing second device 20, and the first device performs the following steps.

Step S31: Receive a piece of information. In the present embodiment, the piece of information is a character string, and the digital data includes a set of binary bits.

Step S32: Convert the piece of information into digital data S. In the present embodiment, the digital data S includes a set of binary bits.

Step S33: Rearrange the digital data to generate a matrix S0. In the present embodiment, the digital data S with a check code added thereto is rearranged to generate the matrix S0.

Step S34: Perform an error control coding algorithm to code and sequentially rearrange data in the matrix S0 in generation of a byte sequence S2.

Step S35: Add a header to the byte sequence S2 to create a bit sequence S3 and then modulate the bit sequence S3 to generate a set of audio signals.

Step S36: Transmit the set of audio signals to the second device 20 for the second device 20 to receive and store. In the present embodiment, the set of audio waves is further compressed.

Step S37: Determine whether to generate a next set of audio signals. If positive, return to step S31.

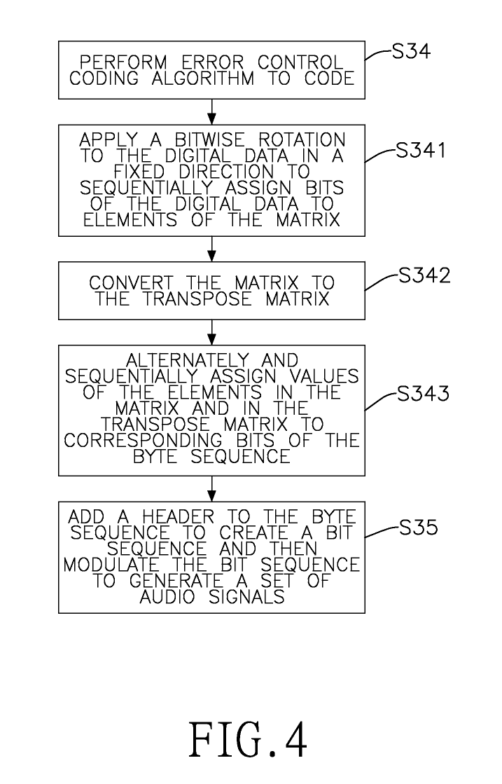

Given the foregoing steps, the first device 10 can transmit audio signals to the second device 20. With reference to FIGS. 2 and 4, step S34 further includes the following steps.

Step S341: Apply a bitwise rotation to the digital data S and the check code in a fixed direction to sequentially assign bits of the digital data S to elements of the matrix S0.

Step S342: Convert the matrix S0 to the transpose matrix Si.

Step S343: Alternately and sequentially assign values of the elements in the matrix S0 and in the transpose matrix Si to corresponding bits of a byte sequence S2. In the present embodiment, the byte sequence S2 is a one-dimensional array.

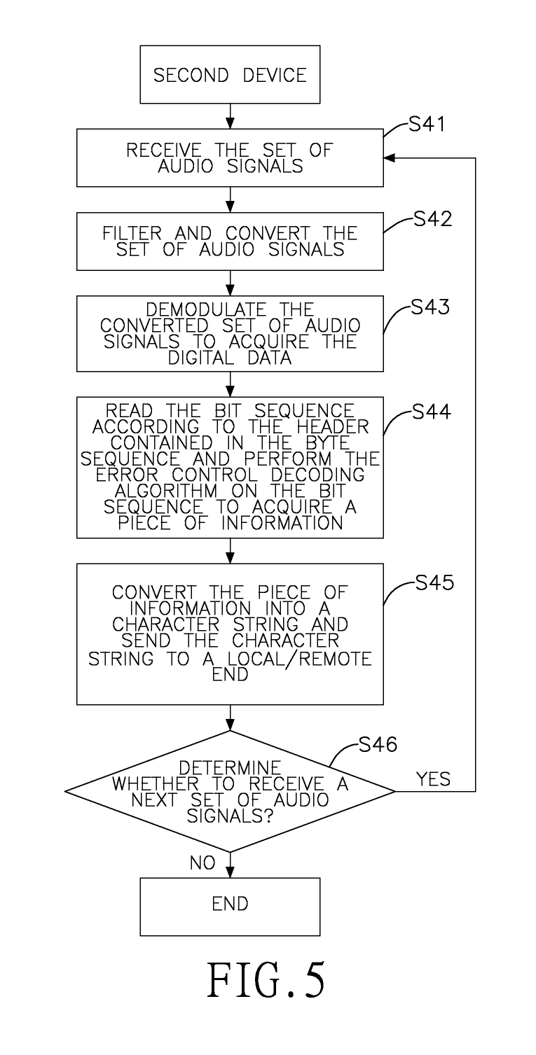

After the first device 10 transmits the set of audio signals to the second device 20 for the second device to receive, with reference to FIG. 5, the second device 20 performs the following steps.

Step S41: Receive the set of audio signals.

Step S42: Filter and convert the set of audio signals. In the present embodiment, the second device 20 filters and demodulates the set of audio signals through a band pass filter and a FFT filter.

Step S43: Demodulate the converted set of audio signals to acquire the digital data S.

Step S44: Read the bit sequence S2 according to the header contained in the byte sequence S3 and perform the error control decoding algorithm on the bit sequence S2 to acquire a piece of information.

Step S45: Convert the piece of information into a character string and send the character string to a local/remote end.

Step S46: Determine whether to receive a next set of audio signals. If positive, return to step S41.

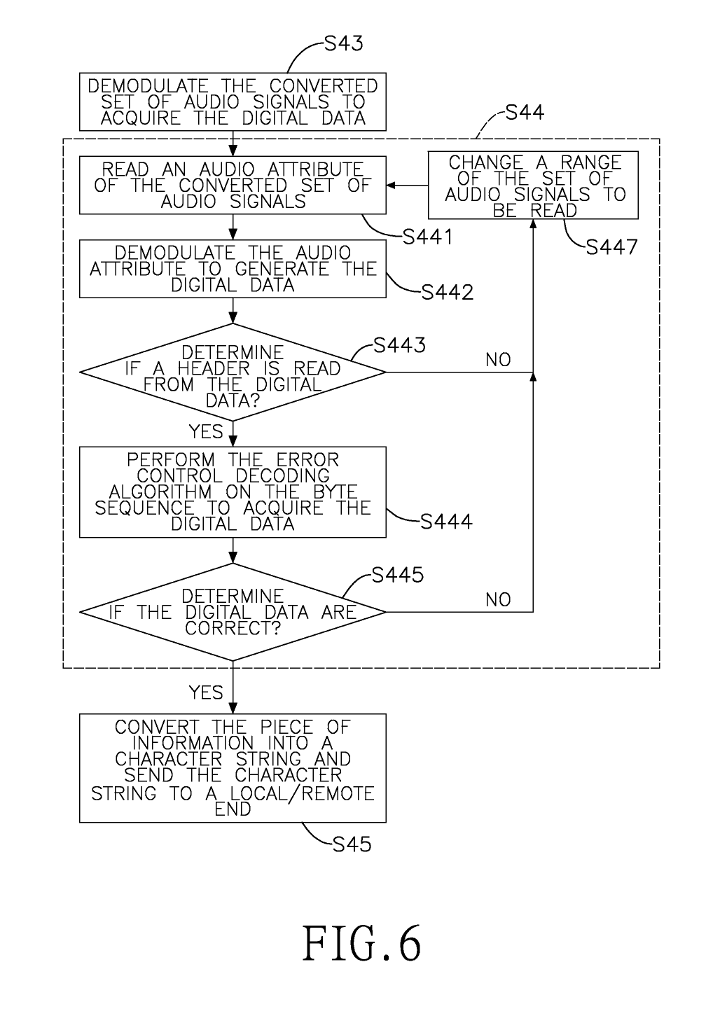

Furthermore, with reference to FIG. 6, step S44 further includes the following steps.

Step S441: Read an audio attribute of the converted set of audio signals.

Step S442: Demodulate the audio attribute to generate the digital data.

Step S443: Determine if a header is read from the digital data. If positive, perform step S444. Otherwise, perform step S447.

Step S444: Read the byte sequence S2.

Step S445: Perform the error control decoding algorithm on the byte sequence S2 to acquire the digital data S.

Step S446: Determine if the digital data are correct with a check code. If positive, perform step S45. Otherwise, perform step S447.

Step S447: Change a range of the set of audio signals to be read and return to step S441.

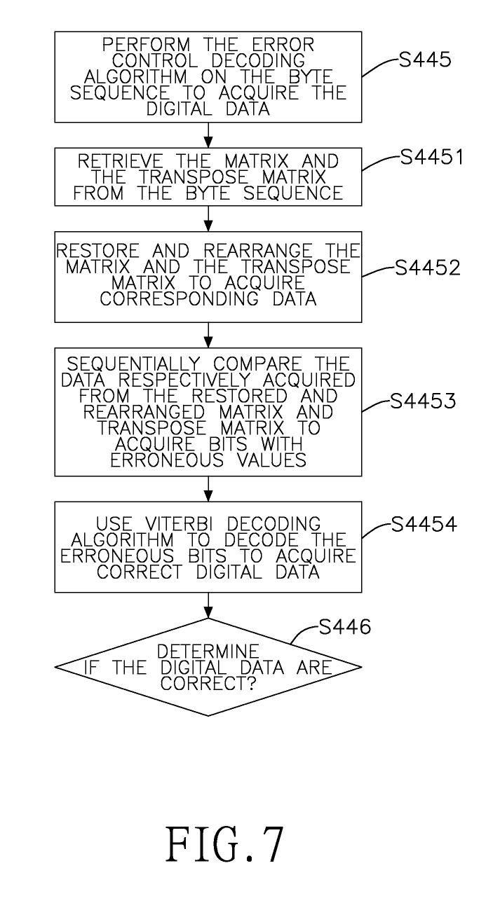

With reference to FIG. 7, step S445 further includes the following steps.

Step S4451: Retrieve the matrix S0 and the transpose matrix Si from the byte sequence S2.

Step S4452: Restore and rearrange the matrix S0 and the transpose matrix Si to acquire corresponding data.

Step S4453: Sequentially compare the data respectively acquired from the restored and rearranged matrix S0 and transpose matrix Si to acquire bits with erroneous values.

Step S4454: Use Viterbi decoding algorithm to decode the erroneous bits to acquire correct digital data S and perform step S446.

By means of the error control coding algorithm and the error control decoding algorithm, the present invention can acquire bits with erroneous values and calculate a shortest path for acquisition of correct information with the highest possibility. In view of overcomplicated computations incapable of being performed by chips in conventional mobile phones, FEC codes are applied for coding and the Viterbi decoding algorithm pairing with the FEC codes for decoding, such that massive erroneous bits occurring upon audio signal transmission can be corrected. Accordingly, the audio signal transmission system and the data processing method can therefore enhance the accuracy of data acquired from audio signal during transmission through the air.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A data processing method for enhancing data accuracy of an audio signal transmission system, wherein the audio signal transmission system has a first device and a second device and the first device transmits audio waves to the second device for the second device to receive, the method performed by the first device and comprising steps of:
receiving a piece of information and converting the piece of information into digital data;
rearranging the digital data to generate a matrix;
performing an error control coding algorithm to code and sequentially rearranging data in the matrix in generation of a byte sequence;
adding a header to the byte sequence to create a bit sequence and then modulating the bit sequence to generate a set of audio signals; and
transmitting the set of audio signals to the second device for the second device to receive.

2. The data processing method as claimed in claim 1, wherein the step of rearranging the digital data to generate the matrix further has a step of adding a check code to the digital data and rearranging the digital data to generate the matrix.

3. The data processing method as claimed in claim 1, further comprising steps of:
compressing the set of audio signals; and
determining whether to generate a next set of audio signals, and if positive, returning to the step of receiving the piece of information.

4. The data processing method as claimed in claim 1, wherein the piece of information is a character string, the piece of information is converted into the digital data, and the digital data include a set of binary bit values.

5. The data processing method as claimed in claim 1, wherein the step of performing the error control coding algorithm to code and sequentially rearranging the data in the matrix in generation of the byte sequence further has steps of:
applying a bitwise rotation to the digital data in a fixed direction to sequentially assign bits of the digital data to elements of the matrix;
converting the matrix to a transpose matrix; and
alternately and sequentially assigning values of the elements in the matrix and in the transpose matrix to corresponding bits of the byte sequence.

6. The data processing method as claimed in claim 5, wherein the byte sequence is a one-dimensional array.

7. The data processing method as claimed in claim 1, wherein the method is performed by the second device and comprises steps of:
receiving the set of audio signals;
converting the set of audio signals;
demodulating the converted set of audio signals to acquire the bit sequence; and
reading the byte sequence according to the header contained in the bit sequence and performing the error control decoding algorithm on the byte sequence to acquire the piece of information.

8. The data processing method as claimed in claim 7, wherein the step of converting the set of audio signals further has a step of filtering and converting the set of audio signals.

9. The data processing method as claimed in claim 7, further comprising steps of:
converting the piece of information into a character string and sending the character string to a local end or a remote end; and
determining whether to receive a next set of audio signals, and if positive, returning to the step of receiving the set of audio signals.

10. The data processing method as claimed in claim 9, wherein the step of reading the byte sequence according to the header contained in the bit sequence and performing the error control decoding algorithm on the byte sequence to acquire the piece of information further has steps of:
reading an audio attribute of the converted set of audio signals;
demodulating the audio attribute to generate the bit sequence;
determining if a header is read from the bit sequence, and if negative, changing a range of the set of audio signals to be read;
reading the byte sequence;
performing the error control decoding algorithm on the byte sequence to acquire the digital data; and
determining if the digital data are correct with a check code, and if negative, changing a range of the set of audio signals to be read and returning to the step of reading the audio attribute of the converted set of audio signals.

11. The data processing method as claimed in claim 10, wherein the step of performing the error control decoding algorithm further has steps of:
retrieving the matrix and the transpose matrix from the byte sequence;
sequentially comparing data respectively contained in the matrix and transpose matrix to acquire bits with erroneous values; and
using Viterbi decoding algorithm to decode the erroneous bits to correctly acquire the digital data.

12. An audio signal transmission system, comprising:
a first device having:
an audio transmitting unit;
a coder; and
a first processor connected to the audio transmitting unit and the coder and transmitting audio signals through the audio transmitting unit;
a second device pairing with the first device and having:
an audio receiving unit receiving the audio signals;
a decoder; and
a second processor connected to the audio receiving unit and the decoder, receiving the audio signals sent from the audio receiving unit, and processing and demodulating the audio signals;
wherein
the first device performs a first data processing method and the first data processing method includes steps of:
receiving a piece of information and converting the piece of information into digital data;
rearranging the digital data to generate a matrix;
performing an error control coding algorithm to code and sequentially rearranging data in the matrix in generation of a byte sequence;
adding a header to the byte sequence to create a bit sequence and then modulating the bit sequence to generate a set of audio signals; and
transmitting the set of audio signals to the second device for the second device to receive; and
the second device performs a second data processing method and the second data processing method includes steps of:
receiving the set of audio signals;
converting the set of audio signals;
demodulating the converted set of audio signals to acquire the bit sequence; and
reading the byte sequence according to the header contained in the bit sequence and performing the error control decoding algorithm on the byte sequence to acquire the piece of information.
